(19) United States
(12) Patent Application Publication
(10) Pub. No.: US 2003/0165134 A1
(43) Pub. Date: Sep. 4, 2003

(54) Method and system for frame synchronization and burst pattern detection in a wireless communication system

(76) Inventors: Michael Low, Kanata (CA); Chandra Mauli Singh, Ottawa (CA); Mohammad Akhter, Kanata (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/327,932

(22) Filed: Dec. 26, 2002

Related U.S. Application Data
(60) Provisional application No. 60/342,123, filed on Dec. 26, 2001.

(51) Int. Cl. H04J 3/06

(52) U.S. Cl. 370/350; 370/503

(57) ABSTRACT

A method and apparatus are provided that perform blind acquisition of a frame burst pattern, i.e. which frames in a particular recurring sequence contain data, without prior knowledge of such information. This is performed based on detecting the presence and location of a unique word in a received frame structure. Preferably, the method and apparatus also perform blind acquisition of frame synchronization, i.e. the ability to know where the frame starts without prior knowledge of such information. Such features can be provided in a frame synchronization device, such as a downlink demodulator, which can be used in a wireless communication system, such as a satellite-based communication system. Activation logic is also provided that activates wireless communication system devices, such as components of the downlink demodulator, based on the determined burst pattern in order to save power.

This application claims the benefit of priority from U.S. Provisional Patent Application Serial No. 60/342,123, filed on Dec. 26, 2001.

### FIELD OF THE INVENTION

The present invention relates generally to wireless communication systems. More particularly, the present invention relates to frame synchronization in demodulators, particularly in satellite-based systems.

### BACKGROUND OF THE INVENTION

Wireless communication systems are used for many different types of data transmission in order to provide a variety of services. Some services require data to be transmitted in a continuous stream, or mode, whereas other services can manage well when data is sent in non-continuous bursts of data. In a burst mode of data transmission, information typically flows in short intense data groupings (often packets or frames) with relatively long silent periods between each transmission burst. These bursts can follow a predefined burst pattern with respect to the data source. For instance, a superframe can contain four frames, with one or more of the frames (or portions thereof) containing data. A frame burst pattern is defined by which frames within a predefined window of observation, such as a superframe, contain data. A service provider may allow a particular customer to transmit data in certain frames or portions thereof, and parameters such as expected service reliability and guaranteed bandwidth can be defined in service level agreements for each customer.

In order for a receiver to properly receive data from a particular customer, the receiver must have knowledge of the composition of a received data stream. In the case of continuous mode transmission, this can be easily achieved by means well known to those of skill in the art. In the case of burst mode transmission, the receiver must have some knowledge of the predefined burst pattern.

Frame synchronization, when referring to a received stream of framed data, is the process by which incoming frame alignment signals, i.e., distinctive bit sequences, are identified. As part of this identification, the frame alignment signals are distinguished from data bits, permitting the data bits within the frame to be extracted for decoding or retransmission. Typically, a non-information bit is inserted in a dedicated time slot within the frame for the actual synchronization of the incoming data with the receiver.

However, there are situations in which the receiver may not know the burst pattern, or such information may not be available from the transmitter. There are also situations in which the burst pattern may change, whether at the request of the customer or the service provider. In either case, there is a need for the receiver to discover and track the burst pattern itself, so that the receiver is able to resynchronize itself within a few symbols of receiving a new burst.

When a transmitter transmits data in continuous mode, the transmitter is typically powered on constantly. In that case, power is being wasted at both the transmitter and receiver during the times when no data is being transmitted. There is a need to improve the power consumption of such transmitters and receivers. One way in which this can be accomplished is to operate the transmitter in burst mode, instead of continuous mode. However, this requires that the receiver also operate in burst mode.

It is, therefore, desirable to provide a method or apparatus that will assist in satisfying at least one of these needs.

### SUMMARY OF THE INVENTION

It is an object of the present invention to obviate or mitigate at least one disadvantage of previous frame synchronization methods or apparatus, particularly those provided for use with wireless communication systems, such as satellite-based systems.

The present invention advantageously provides a method and apparatus that perform blind acquisition of a frame burst pattern, i.e. which frames are on (contain data) and which frames are off (do not contain data) without prior knowledge of such information. In a preferred embodiment, the method and apparatus also performs blind acquisition of frame synchronization, i.e. the ability to know where the frame starts without prior knowledge of such information. When coupled with a provided activation logic, it is possible to save power by only providing power to a needed device when it is known ahead of time that valid data is to be expected in a particular frame. For frames in which it is known that valid data is not expected, the devices can advantageously be powered off.

According to an aspect of the present invention, there is provided a frame synchronization system for a wireless communication system. The system includes the following components: an in-frame position detector for calculating a current position within a received frame based on a comparison between a stored distance and a distance between previously detected unique words in previous received frames; a burst pattern learner for determining a burst pattern based on the current position and on the location of the previously detected unique words in the previous received frames; and an activation logic device for activating and disabling various devices at an appropriate time based on the determination of the burst pattern.

The frame synchronization system can further include a unique word detector for detecting a unique word in a received frame. The wireless communication system can be a satellite-based communication system, and the frame synchronization system can be comprised in a downlink demodulator.

According to another aspect of the present invention, there is provided an apparatus for use in a wireless communication system. The apparatus includes: a determination module for determining a location of a first field and a second field in a received frame, the first and second fields containing a detected unique word; a frame storage module for storing an array of received frames, the array including an indication of which frames contain data; and a processing module for determining a burst pattern based on the contents of the array and on the location of the first and second fields in the received frames.

The processing module can include means for examining the pattern of detected unique words in the array. The apparatus can further include a frame position verification module for verifying that a current position in a received frame is not based on a false detection. The size of the array stored in the frame storage module can be a multiple of the size of a known possible burst pattern, preferably of the longest known possible burst pattern. The array preferably includes a sliding window of sequentially received frames.

The apparatus can further include a burst pattern determination indicator module for indicating when a burst pattern has been determined based on the result of the processing module. The apparatus can also further include an expected data frame indicator module for indicating when a received frame is expected to contain data, based on the result of the determined burst pattern. Additionally, the apparatus can include an activation logic module for activating a wireless communication system device only when a received frame is expected to contain data, based on the determined burst pattern.

According to a further aspect of the present invention, there is provided an apparatus for performing frame synchronization in a wireless communication system in which a received frame structure includes a unique word in at least a first and second field of a received frame. The apparatus includes: a measuring device for measuring a distance between a detected unique word and a most recently detected unique word; a comparing device for comparing the measured distance with a stored distance; and a calculating device for calculating a current position within the received frame based on a match between the measured distance and the stored distance. The stored distance can be a distance between the first field and the second field of one received frame, or a distance between the second field of a given received frame and the first field of an immediately preceding received frame.

The apparatus can further include a symbol count module for initializing a symbol count after a unique word is detected. The calculating device can include means for examining the number of symbols elapsed between the most recent detection and an arbitrary number of past detections. The comparing device can include means for comparing future detections of a unique word with an expected position of a first unique word field and a second unique word field in a future received frame, with the expected positions of the first and second unique word fields preferably being based on the calculated current position. The received frame can be a downlink frame.

According to a yet further aspect of the present invention, there is provided a method of learning a frame burst pattern in a satellite communication system. The method includes the steps of: determining a location of a first field and a second field in a received frame, the first and second fields containing a detected unique word; storing an array of received frames, the array including an indication of which frames contain data; and determining a burst pattern based on the contents of the array and on the location of the first and second fields in the received frames.

According to a still further aspect of the present invention, there is provided a method of performing frame synchronization in a wireless communication system in which a received frame structure includes a unique word in at least a first and second field of a received frame. The method includes the steps of: measuring a distance between a detected unique word and a most recently detected unique word; comparing the measured distance with a stored distance; and calculating a current position within the received frame based on a match between the measured distance and the stored distance.

### BRIEF DESCRIPTION OF THE DRAWINGS

Embodiments of the present invention will now be described, by way of example only, with reference to the attached Figures, wherein:

FIG. 1 illustrates a frame synchronization system according to the present invention as part of a downlink demodulator structure;

FIG. 2 illustrates a frame synchronization system structure according to the present invention;

FIG. 3 illustrates a general finite-impulse response filter structure according to the present invention;

FIG. 4 illustrates an example of a downlink frame whose structure may be exploited by a frame synchronization according to the present invention;

FIG. 5 illustrates a flowchart of the operation of the frame synchronization device in acquisition mode; and

FIG. 6-FIG. 9 illustrate flowcharts of the operation of the frame synchronization device in tracking mode.

### DETAILED DESCRIPTION

Generally, the present invention provides a method and apparatus that perform blind acquisition of a frame burst pattern, i.e. which frames in a particular recurring sequence contain data, without prior knowledge of such information. This is performed based on detecting the presence and location of a unique word in a received frame structure. Preferably, the method and apparatus also perform blind acquisition of frame synchronization, i.e. the ability to know where the frame starts without prior knowledge of such information. Such features can be provided in a frame synchronization device, such as a downlink demodulator, which can be used in a wireless communication system, such as a satellite-based communication system. Activation logic is also provided that activates wireless communication system devices, such as components of the downlink demodulator, based on the determined burst pattern in order to save power

The frame synchronization system described in this document consists of three primary components:

PN (pseudo-random number) sequence detector

Frame synchronization device

Activation logic

The above-listed components are described in detail below. Their use is explained with respect to a particular example in which the components co-operate in order to achieve frame synchronization in a satellite-based communications system.

Although described in relation to a satellite-based communications system, the principles of the present invention can be applied with equal effectiveness in a general wireless communications system in which the received frame structure contains two PN sequences.

The particular embodiment described herein was designed to work with a symbol timing recovery algorithm having the following characteristics: the ability to operate in both burst and continuous mode; and the ability to resynchronize within a few symbols of receiving a new burst. The downlink data rate that the embodiment was designed for is 196.7 million symbols per second. The transmitted data is pulse shaped using a root-raised cosine filter with an excess bandwidth factor of α=0.25. There can be a break of up to 54368 symbols between two successive received bursts; this occurs when the first frame is a Power Gate (i.e. half normal duration) frame and there is a three frame silence before receiving the next frame. Of course, these are all characteristics of a particular implementation, and variations in the downlink data rate, filter characteristics, burst breaks and other characteristics can be varied.

Additional preferable characteristics of the symbol timing recovery algorithm are as follows: minimal implementation loss; ability to operate under +/−-100 kHz carrier offset conditions; and ability to operate under the transmitter impairments present in the signal files provided by TRW; i.e. framedata₁₃ nom.ascsig and framedata_spec.ascsig. In terms of the implementation loss, the allowable implementation margin for the entire baseband receiver is 0.8 dB, therefore the loss attributable to the timing recovery device alone should be much less than this value.

The frame synchronization system of the present invention as described below is designed to permit a symbol timing recovery algorithm to operate satisfactorily according to the above characteristics. Of course, embodiments of the present invention can be used in conjunction with a wide variety of symbol timing recovery algorithms, with the necessary modifications being obvious to one of ordinary skill in the art.

The frame synchronization system makes use of the presence of a unique word in a downlink frame. A unique word is a known specific bit pattern having good auto-correlation properties, such as a PN sequence. In a particular example, a 63-bit PN sequence in the PN Sync 1 and PN Sync 2 fields of the downlink frame is the unique word used in order to establish frame timing. Although the use of a unique word for frame synchronization has been previously considered, the present invention uses unique words for learning, recognizing or identifying a frame burst pattern.

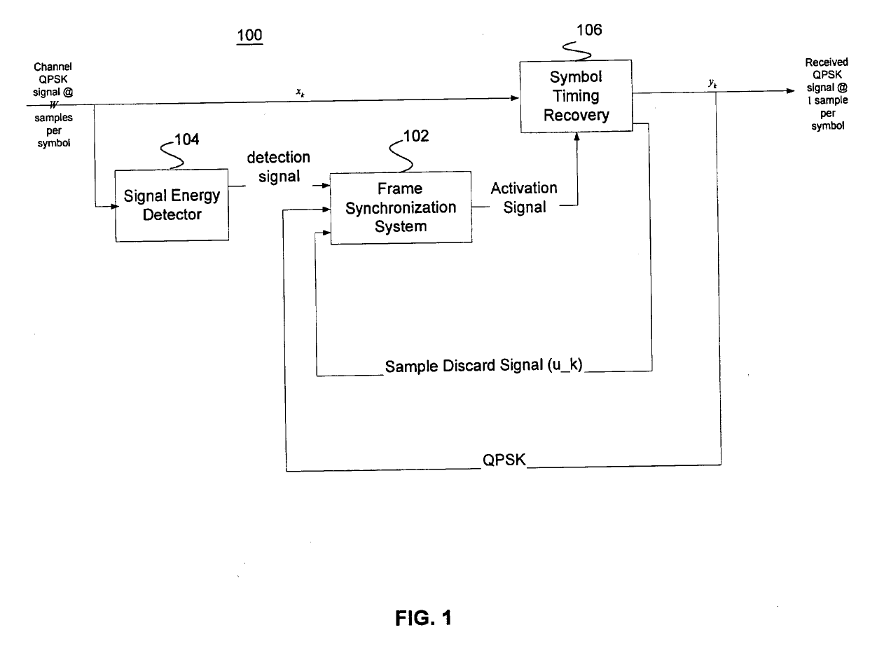

FIG. 1 illustrates a frame synchronization system 102 according to the present invention as part of a downlink demodulator structure 100. The connection of the frame synchronization system 102 to other parts of the downlink demodulator, or receiver, is shown in FIG. 1. Illustrated in FIG. 1 are a signal energy detector 104, which detects the presence of a signal, and a symbol timing recovery device 106, which implements a symbol timing recovery algorithm. The sample discard signal u_k shown in FIG. 1 is specific to the type of symbol timing recovery algorithm described in this particular example and may not be necessary with alternative implementations.

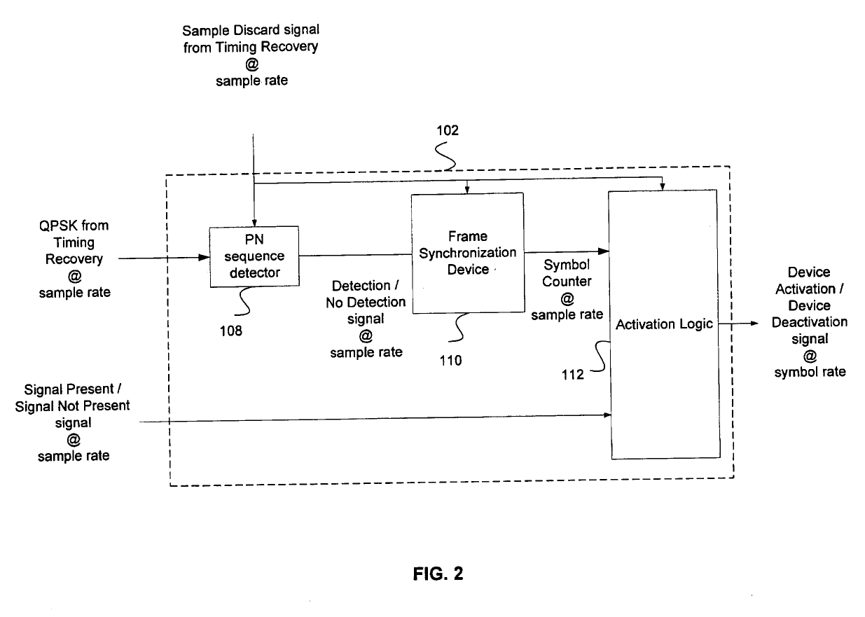

FIG. 2 illustrates the structure of the frame synchronization system 102 having three components: a PN sequence detector 108, a frame synchronization device 110, and activation logic 112. Each of these components is described in more detail in the sections below. The inputs to the frame synchronization system are described later in Table 3.

PN Sequence Detector

This device is responsible for detecting the presence of the PN sequence within the downlink frame.

Principles of Operation

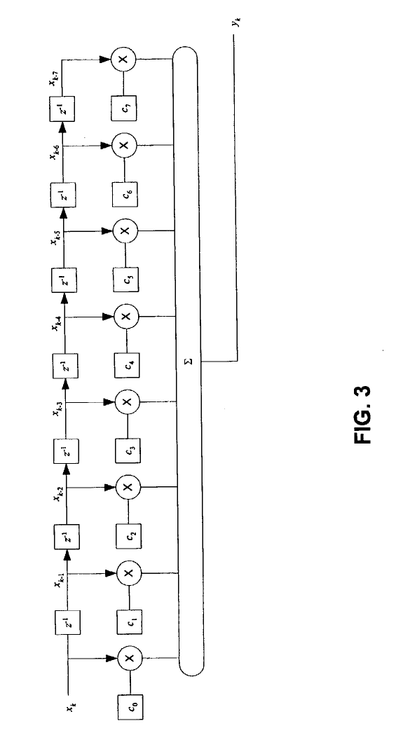

The PN sequence detector is essentially a filter having a number of taps equal to the length of the PN sequence used. The PN sequence detector, or unique word detector, preferably consists of two correlation filters. FIG. 3 illustrates a general finite-impulse response filter structure. The correlation filters preferably used are feed-forward filters, similar to the one shown in, except that there would be a number of taps equal to the length of the PN sequence in symbols. A PN sequence length used in a preferred embodiment is 63. The tap values are those of the PN sequence, as represented in symbols. That is, a bit “0” is mapped to the symbol “1” and a bit “1” is mapped to the symbol “−1”, as per the bit-to-symbol coding described in the specifications.

Since the frame synchronization device directly follows the symbol timing recovery device, a separate correlation filter is required for the I and Q channel in order to be able to robustly detect the PN sequence in the presence of a frequency offset.

The output of each of the correlation filters is added, and the sum is compared to a well-chosen, fixed threshold. If the output exceeds the threshold, the detector output is TRUE; otherwise it is FALSE. This device receives data at the sample rate, but a control signal from the timing recovery device indicates which samples to discard such that the PN sequence detector produces valid output at the rate of 1 sample per symbol.

Port Description

The inputs and outputs of the PN sequence detector are described in Table 1 and Table 2, respectively.

TABLE 1
PN sequence detector input description

| Port Name | Description |
|---|---|
| In | This input shall be connected to either the I or the Q |
| | channel of the symbol timing recovery device, as shown in. |
| Hold | This input shall be connected to the u_k output of the timing |
| | recovery block. A TRUE shall be provided when the input |
| | sample is to be processed, and a FALSE shall be provided |
| | when the input sample is to be ignored. |

TABLE 2
PN sequence detector output description

| Port Name | Description |
|---|---|
| pn_detection | If the correlation filter output exceeds a fixed threshold, |
| | then this output is TRUE; otherwise it is FALSE. |

Frame Synchronization Device

The purpose of the frame synchronization device is to establish the position of the downlink demodulator within the downlink received frame, and to learn and track the frame burst pattern. The first purpose can be achieved by way of an in-frame position detector within the device; the second purpose can be achieved by way of a burst pattern learner within the device. Of course, these can be advantageously housed within the same device and can even advantageously share some software, firmware or hardware components.

Principles of Operation

Two possible modes of operation can be defined: Acquisition mode and Tracking mode. In Acquisition mode, this device attempts to establish the demodulator's position within a frame. In Tracking mode, the logic attempts to learn and track the frame burst pattern.

Acquisition Mode

In Acquisition mode, the frame synchronization device continually increments a counter acqSymCount until a detection is received from the PN sequence detector, at which time the counter is reset to 0.

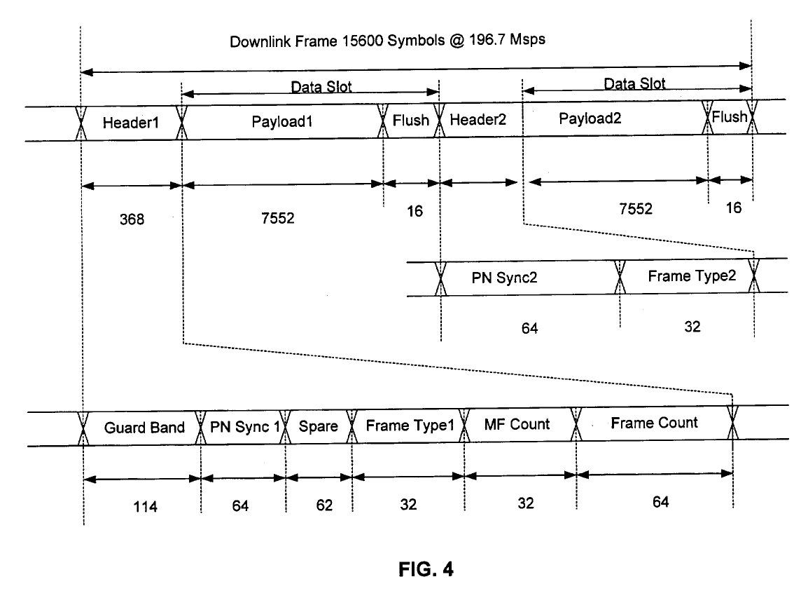

There are two possible correct detections in one frame: one in PN Sync 1, and one in PN Sync 2. In a preferred embodiment, there are up to five possible correct detections in one frame, namely: two in the Guard Band, one in PN Sync 1, one in the Spare, and one in PN Sync 2. FIG. 4 illustrates an example of a downlink frame whose structure may be exploited by a frame synchronization according to the present invention. The frame structure shows various fields with their preferred length in number of symbols. The Guard Band is essentially “padding” that allows for garbage data while a transmitter is being turned on.

In order to distinguish between all these possible detections, as well as any false detection due to noise, the device preferably examines the number of symbols elapsed between the most recent detection, and an arbitrary number of past detections. The determination of the location of the fields in a given frame in which the unique words are contained is preferably achieved by way of a determination module provided in the device.

With specific reference to the example described herein and illustrated in FIG. 4, the distance between PN Sync 2 and PN Sync 1 of a given frame is 7822 symbols. The distance between PN Sync 1 of a given frame and PN Sync 2 of the previous frame is 7714 symbols. Therefore, when a PN sequence is detected, if the number of symbols elapsed between the present detection and, for example, the third most recent detection is 7822 symbols, then the frame synchronization device knows that the demodulator block has just received the second last symbol of PN Sync 2. The demodulator's position within a frame is therefore known, and the frame synchronization device begins operating in Tracking mode.

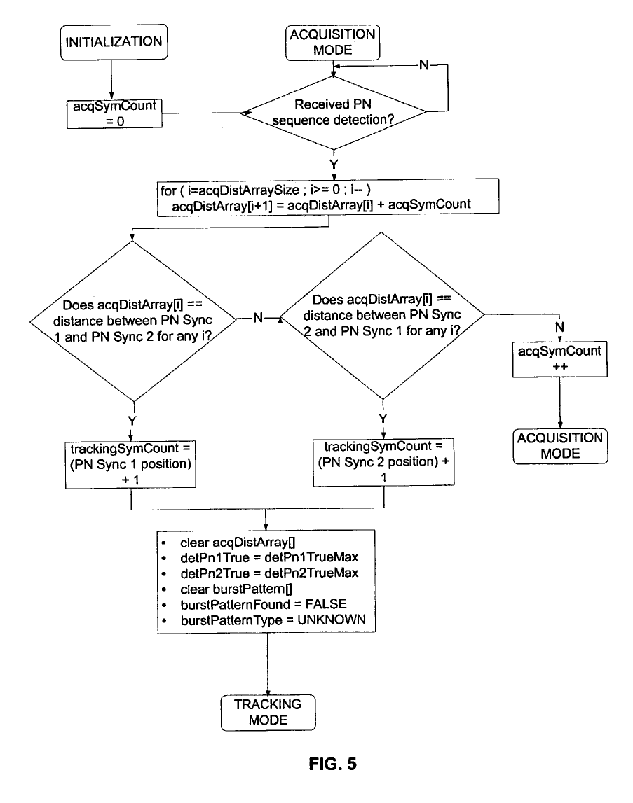

A flow chart illustrating the operation of the frame synchronization device in Acquisition mode is shown in FIG. 5.

Tracking Mode

Two possible sub-modes of operation within Tracking mode can be defined. These are advantageously defined in relation to a burst pattern determination indicator module that is preferably provided in the device, which can be implemented as a variable burstPatternFound. The sub-modes can be defined as follows:

when the frame burst pattern is not known (i.e. when burstPatternFound is FALSE)

when the frame burst pattern is known (i.e. when burstPatternFound is TRUE)

An expected data frame indicator module is also preferably provided in the device, which can be implemented as a variable expectDataFrame. The variable expectDataFrame is updated at the beginning of each frame in the following manner:

When burstPatternFound is FALSE, expectDataFrame is always set to TRUE.

When burstPatternFound is TRUE, expectDataFrame is set to TRUE if the upcoming data frame is known to contain data; otherwise it is set to FALSE.

Upon switching from Acquisition mode to Tracking mode, burstPatternFound is set to FALSE, and the frame synchronization device begins checking whether it has correctly established the demodulator's position within the frame. This is preferably achieved by a frame position verification module in the device.

Due to the presence of noise and the random nature of the data in a downlink frame, it is possible that the PN sequence detector may register one or more false detections. Therefore, it is theoretically possible, although very unlikely, that the distance in symbols between two such detections is equal to either the distance between PN Sync 2 and PN Sync 1 of a given frame, or the distance between PN Sync 1 of a given frame and PN Sync 2 of the previous frame. If either of these two conditions were to occur, the frame synchronization device would incorrectly establish the demodulator's position within the downlink frame. In order to verify that the frame synchronization device's estimate of the demodulator's position is correct, it is necessary to check that future detections of the PN sequence occur at symbol position 176 and at symbol position 7998; that is, where the frame synchronization device believes PN Sync 1 and PN Sync 2 to be, respectively.

If detection is obtained at the end of PN Sync 1, then the counter detPn1True is incremented by one, up to the maximum value set by the constant detPn1TrueMax; if no detection is obtained at the end of PN Sync 1, detPn1True is decremented by one, down to the minimum value set by the constant detPn1TrueMin. Similarly, detPn2True tracks the number of correct detections at the end of PN Sync 2.

If either detPn1True or detPn2True is caused to be decremented down to detPn1TrueMin and detPn2TrueMin, respectively, then it is most likely that the frame synchronization device has incorrectly established the demodulator's position within the downlink frame, and therefore the frame synchronization device is forced back to Acquisition mode.

When either:

burstPatternFound is FALSE; or

burstPatternFound is TRUE and expectDataFrame is TRUE,

and if a PN sequence is detected in either PN Sync 1 or PN Sync 2, then the frame presently being received is considered to contain valid data; otherwise it is considered to contain no data.

When burstPatternFound is TRUE and expectDataFrame is FALSE, and a PN sequence is detected in both PN Sync 1 and PN Sync 2, then the frame presently being received is considered to contain valid data; otherwise it is considered to contain no data. This double detection is required so that the frame synchronization device can be certain that the present frame actually contains data, even though no data was expected.

A frame storage module is provided in the device for storing an array of received frames. An array burstpattem[] is provided which preferably stores a sliding window of sequentially received frames. In a particular embodiment, the array has a size of 24 frames and records which of the past 24 frames do and do not contain data. If the present frame contains data, TRUE is stored in burstPattem[0]; otherwise, FALSE is stored. Similarly, the entry burstpattern[x] stores TRUE if the xth previous frame contained data; otherwise FALSE is stored. The contents of burstpattern[] are shifted and updated once per frame.

Regarding the size of the array burstPattern[], in this preferred embodiment, the second-longest burst pattern has a period of 3 frames (e.g. “1 data frame, 2 silent frames”) and the longest burst pattern has a period of 4 frames (e.g. “1 data frame, 3 silent frames”). Therefore, the burst pattern can be established by examining the pattern of PN sequence detections over a minimum of 12 frames. The size of the array is therefore a multiple of a known possible burst pattern, and preferably a multiple of the longest known possible burst pattern.

In order to increase confidence that the burst pattern has indeed been established, this synchronizer compares the detection pattern over two consecutive sliding windows, each of which is 12 frames in length. This is preferably achieved by way of a processing module provided in the device. If the pattern in the first window is identical to the pattern in the second window, then it is decided that the burst pattern has been detected. Note that in this preferred design, a minimum of 24 frames elapses, after entering Tracking mode from Acquisition mode, before the burst pattern can be established. Similarly, a minimum of 24 frames elapses before a change in burst pattern can be established. The flow chart of the operation of the frame synchronization device in Tracking mode is shown in,, and .

This device receives data at the sample rate, but a control signal from the timing recovery device indicates which samples to discard such that the frame synchronization device produces valid output at the rate of 1 sample per symbol.

Activation Logic

The purpose of the activation logic is to activate and disable the various demodulator devices (e.g. symbol timing recovery device, carrier recovery device, and equalizer) at the appropriate time. The activation logic can be implemented as an activation logic device, or as an activation logic module. The activation logic (in either module or device form) is able to receive information from the frame synchronization device, and is preferably in communication with the frame synchronization device.

The following logic is used. If the frame synchronization device is in either:

Acquisition mode; or

Tracking mode, but the burst pattern is not yet known,

then a wireless communication system device, such as each of the demodulator devices, should be activated when the output of the signal detection device crosses a well-chosen detection threshold, thus indicating, with high probability, that a valid signal is present. This action is performed in this state because it is not known exactly when data will be received. Activation generally represents providing power to a particular device.

If the frame synchronization device is in Tracking mode, and the burst pattern is known, then the receiver devices should be activated when the frame synchronization device's symbol counter indicates that the first symbol of PN Sync 1 of a data frame is about to be received

In the case of Power Gate type frames where no signal is transmitted during Payload 2, it is desirable to deactivate the receiver devices in order to conserve power. This is accomplished by decoding the Frame Type 2 field in the downlink frame and then asserting the signal to deactivate the demodulator devices for the duration of Payload 2 if necessary.

This device receives data at the sample rate, but a control signal from the timing recovery device indicates which samples to discard such that the activation logic produces valid output at the rate of 1 sample per symbol.

Port Description

The inputs and outputs of the frame synchronization system are described in Table 3 and Table 4, respectively. The control parameters are described in Table 5. The frame synchronization system operates at the nominal rate of 1 sample per symbol.

TABLE 3
Frame synchronization system input description

| Port Name | Description |
|---|---|
| pn_detection | This input shall be connected to the output of the PN |
| | sequence detector device shown in. A FALSE shall be |
| | provided when there is no detection and a TRUE shall be |
| | provided when there is a detection. |
| signal_present | This input shall be connected to the output of the receiver |
| | signal detector shown in. TRUE shall be provided when |
| | a signal is present; otherwise FALSE shall be provided. |
| hold | This input shall be connected to the u_k output of the |
| | timing recovery block. A TRUE shall be provided when |
| | the input sample is to be processed, and a FALSE shall |
| | be provided when the input sample is to be ignored. |

TABLE 4
Frame synchronization system output description

| Port Name | Description |
|---|---|
| frame_strobe | In Acquisition mode, this output is always set to |
| | FALSE. |
| | In Tracking mode, this output is set to TRUE when |
| | symbol_count is 0. |
| | When hold is TRUE, this output is always set to |
| | FALSE. This is done in order to prevent this strobe |
| | from having a duration greater than T_{S}. This is |
| | important because this output is an input to the device |
| | that measures downlink frequency accuracy. |
| activate | This output is TRUE when the receiver devices are |
| | should be activated; otherwise it is FALSE. |
| symbol_count | In Acquisition mode, this output provides the number |
| (diagnostic only) | of symbols elapsed since the last PN sequence |
| | detection (i.e. the current value of acqSymCount.) |
| | In Tracking mode, this output provides the number of |
| | symbols elapsed since the start of the present frame |
| | (i.e. the current value of trackingSymCount.) |
| frame_mute | In Acquisition mode, this output is always set to |
| (diagnostic only) | FALSE. |
| | In Tracking mode, when the burst pattern is not |
| | known, this output is always set to FALSE. |
| | In Tracking mode, when the burst pattern is known, |
| | this output is set to TRUE when the present frame is |
| | known to contain no data. |
| sync_mode | In Acquisition mode, this output is always set to |
| (diagnostic only) | FALSE. |
| | In Tracking mode, this output is always set to TRUE. |
| det_pn1 | In Acquisition mode, this output is always set to the |
| (diagnostic only) | value of parameter detPn1TrueMin. |
| | In Tracking mode, when the burst pattern is not |
| | known, this output reports the number of correct |
| | detections of the PN sequence in the PN Sync 1 field |
| | for all frames since the synchronizer entered Tracking |
| | mode. |
| | In Tracking mode, when the burst pattern is known, |
| | this output reports the number of correct detections of |
| | the PN sequence in the PN Sync 1 field for only those |
| | frames that are known to contain valid data. |
| | The minimum and maximum allowable values are |
| | defined by parameters detPn1TrueMin and |
| | detPn1TrueMax, respectively. |
| det_pn2 | In Acquisition mode, this output is always set to the |
| (diagnostic only) | value of parameter detPn2TrueMin. |
| | In Tracking mode, when the burst pattern is not |
| | known, this output reports the number of correct |
| | detections of the PN sequence in the PN Sync 2 field |
| | for all frames since the synchronizer entered Tracking |
| | mode. |
| | In Tracking mode, when the burst pattern is known, |
| | this output reports the number of correct detections of |
| | the PN sequence in the PN Sync 2 field for only those |
| | frames that are known to contain valid data. |
| | The minimum and maximum allowable values are |
| | defined by parameters detPn2TrueMin and |
| | detPn2TrueMax, respectively. |
| burst_pattern | In Acquisition mode, this output is always set to “0”. |
| (diagnostic only) | In Tracking mode, the possible values are: |
| | “0” when the frame burst pattern is not known or the |
| | burst pattern is not recognized |
| | “1” when the frame burst pattern is continuous |
| | “2” when the frame burst pattern is “1 data frame, |
| | 1 silent frame” |
| | “3” when the frame burst pattern is “2 data frames, |
| | 1 silent frame” |
| | “4” when the frame burst pattern is “1 data frame, |
| | 2 silent frames” |
| | “5” when the frame burst pattern is “3 data frames, |
| | 1 silent frame” |
| | “6” when the frame burst pattern is “1 data frame, |
| | 3 silent frames” |

TABLE 5
Frame synchronization system control parameters

| Parameter | |
|---|---|
| Name | Description |
| detPn1TrueMin | This parameter sets the lower limit for the variable |
| | detPn1True. |
| detPn1TrueMax | This parameter sets the upper limit for the variable |
| | detPn1True. |
| detPn2TrueMin | This parameter sets the lower limit for the variable |
| | detPn2True. |
| detPn2TrueMax | This parameter sets the upper limit for the variable |
| | detPn2True. |

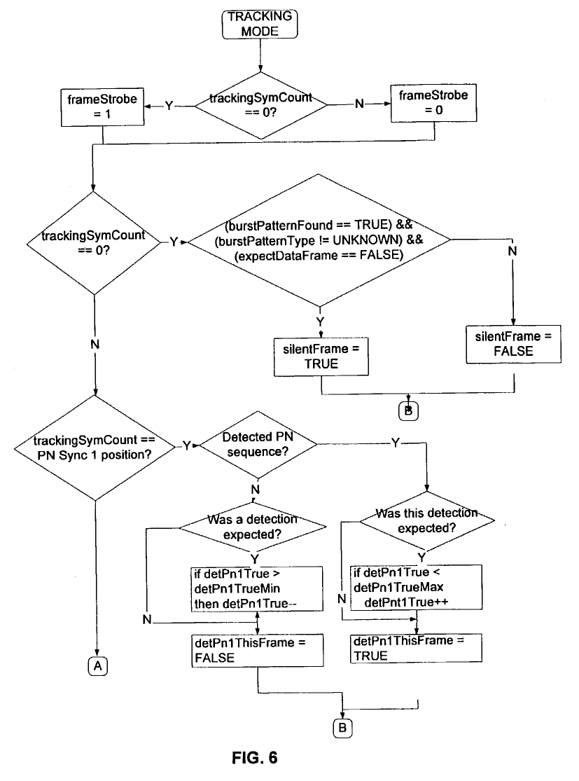

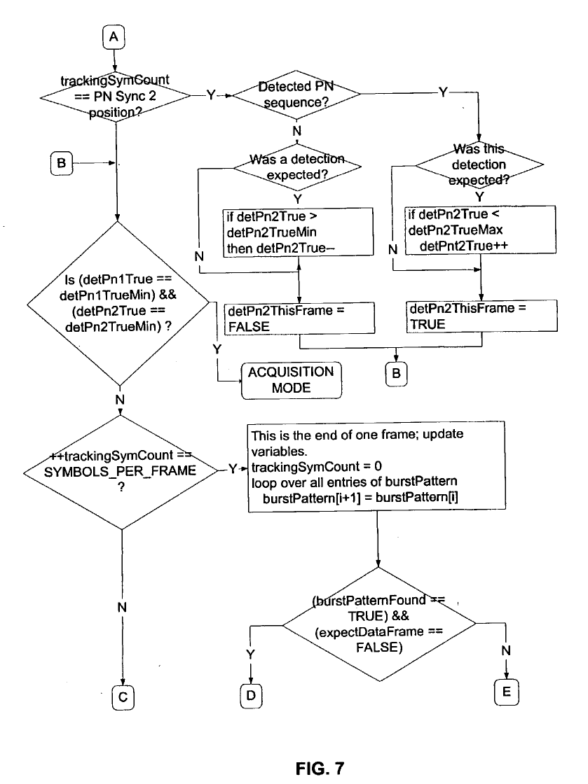

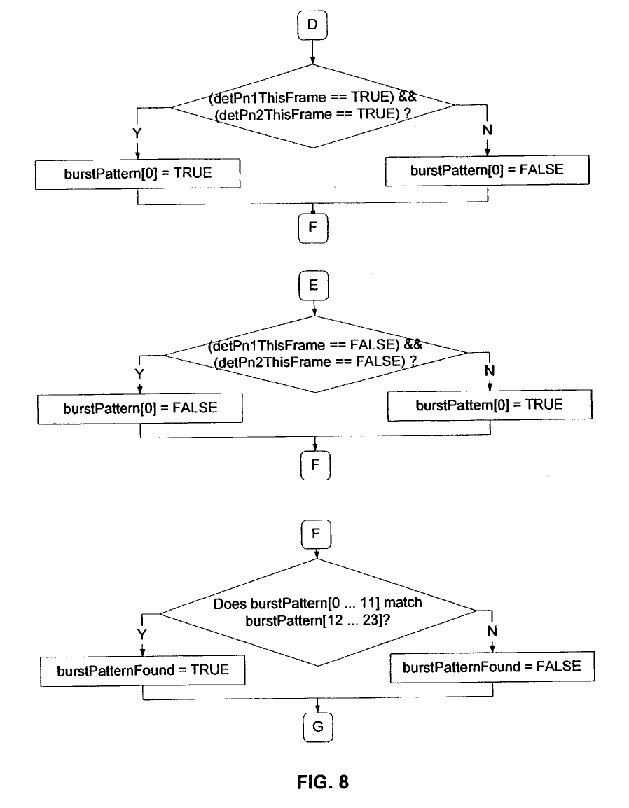

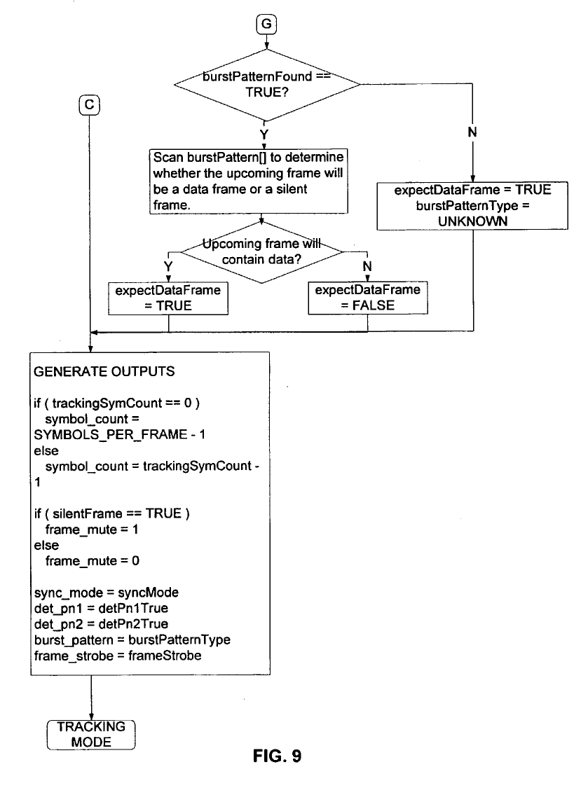

FIG. 6-FIG. 9 illustrate flowcharts of the operation of the frame synchronization system in tracking mode. The flowcharts are self-explanatory and describe the steps involved in relation to the variables and values discussed in detail above.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A frame synchronization system for a wireless communication system, comprising:
an in-frame position detector for calculating a current position within a received frame based on a comparison between a stored distance and a distance between previously detected unique words in previous received frames;
a burst pattern learner for determining a burst pattern based on the current position and on the location of the previously detected unique words in the previous received frames; and
an activation logic device for activating and disabling various devices at an appropriate time based on the determination of the burst pattern.

2. A frame synchronization system according to claim 1 further comprising a unique word detector for detecting a unique word in a received frame.

3. A frame synchronization system according to claim 1 wherein the wireless communication system is a satellite-based communication system.

4. A frame synchronization system according to claim 1 wherein the frame synchronization system is comprised in a downlink demodulator.

5. An apparatus for use in a wireless communication system comprising:
a determination module for determining a location of a first field and a second field in a received frame, the first and second fields containing a detected unique word;
a frame storage module for storing an array of received frames, the array including an indication of which frames contain data; and
a processing module for determining a burst pattern based on the contents of the array and on the location of the first and second fields in the received frames.

6. An apparatus according to claim 5 wherein the processing module comprises means for examining the pattern of detected unique words in the array.

7. An apparatus according to claim 5 further comprising a frame position verification module for verifying that a current position in a received frame is not based on a false detection.

8. An apparatus according to claim 5 wherein the size of the array is a multiple of the size of a known possible burst pattern.

9. An apparatus according to claim 5 wherein the size of the array is a multiple of the size of the longest known possible burst pattern.

10. An apparatus according to claim 5 wherein the array includes a sliding window of sequentially received frames.

11. An apparatus according to claim 5 further comprising a burst pattern determination indicator module for indicating when a burst pattern has been determined based on the result of the processing module.

12. An apparatus according to claim 5 further comprising an expected data frame indicator module for indicating when a received frame is expected to contain data, based on the result of the determined burst pattern.

13. An apparatus according to claim 5 further comprising an activation logic module for activating a wireless communication system device only when a received frame is expected to contain data, based on the determined burst pattern.

14. An apparatus for performing frame synchronization in a wireless communication system in which a received frame structure includes a unique word in at least a first and second field of a received frame, comprising:
a measuring device for measuring a distance between a detected unique word and a most recently detected unique word;
a comparing device for comparing the measured distance with a stored distance; and
a calculating device for calculating a current position within the received frame based on a match between the measured distance and the stored distance.

15. The apparatus of claim 14 wherein the stored distance comprises a distance between the first field and the second field of one received frame.

16. The apparatus of claim 14 wherein the stored distance comprises a distance between the second field of a given received frame and the first field of an immediately preceding received frame.

17. The apparatus of claim 14 further comprising a symbol count module for initializing a symbol count after a unique word is detected.

18. The apparatus of claim 14 wherein the calculating device comprises means for examining the number of symbols elapsed between the most recent detection and an arbitrary number of past detections.

19. The apparatus of claim 14 wherein the comparing device comprises means for comparing future detections of a unique word with an expected position of a first unique word field and a second unique word field in a future received frame.

20. The apparatus of claim 19 wherein the expected positions of the first and second unique word fields are based on the calculated current position.

21. The apparatus of claim 14 wherein the received frame comprises a downlink frame.

22. A method of learning a frame burst pattern in a satellite communication system comprising the steps of:
determining a location of a first field and a second field in a received frame, the first and second fields containing a detected unique word;
storing an array of received frames, the array including an indication of which frames contain data; and
determining a burst pattern based on the contents of the array and on the location of the first and second fields in the received frames.

23. A method of performing frame synchronization in a wireless communication system in which a received frame structure includes a unique word in at least a first and second field of a received frame, comprising the steps of:
measuring a distance between a detected unique word and a most recently detected unique word;
comparing the measured distance with a stored distance; and
calculating a current position within the received frame based on a match between the measured distance and the stored distance.
